(19) United States
(12) Patent Application Publication
(10) Pub. No.: US 2026/0037409 A1
(43) Pub. Date: Feb. 5, 2026

(54) DIAGNOSING FAILURES IN A CODE PIPELINE

(71) Applicant: Capital One Services, LLC, McLean, VA (US)

(72) Inventor: Aaron ATTAR, Dallas, TX (US)

(21) Appl. No.: 18/792,392

(22) Filed: Aug. 1, 2024

(51) Int. Cl. G06F 11/36; G06F 8/71

(52) U.S. Cl. CPC G06F 11/3636; G06F 8/71; G06F 11/366

(57) ABSTRACT

In some implementations, a fault diagnosis system may track information associated with a first execution of a code pipeline to deploy an updated version of software associated with the code pipeline. The fault diagnosis system may receive an indication of a failure in a second execution of the code pipeline, wherein the second execution of the code pipeline is triggered by a commit of source code to a source code repository. The fault diagnosis system may determine whether the updated version of the software associated with the code pipeline or the source code committed to the source code repository is a cause of the failure in the second execution of the code pipeline. The fault diagnosis system may send a request to plan code development to resolve the cause of the failure in the second execution of the code pipeline.

### BACKGROUND

In software engineering, continuous integration and continuous deployment (CI/CD), sometimes referred to as continuous integration and continuous delivery, generally includes techniques to combine continuous integration (CI) and continuous deployment (CD) practices to automate most or all of the manual human intervention traditionally needed to move new code from a commit into production (e.g., including a build phase, a test phase, and a deploy phase, as well as infrastructure provisioning). For example, continuous integration practices include techniques to frequently merge small code updates into a main branch of a shared source code repository, automatically test each change when code is committed or merged, and initiate a build. In this way, continuous integration allows errors and security issues to be identified and fixed more easily, and much earlier in the development process. Furthermore, continuous deployment practices enable organizations to deploy applications automatically, eliminating the need for human intervention. With continuous deployment, DevOps (developer and operations) teams set the criteria for code releases in advance, and the code is automatically deployed to a production environment when the criteria are satisfied and validated. Additionally, or alternatively, continuous delivery is a software development practice used to automate the infrastructure provisioning and application release process, where code is packaged with the data needed to be deployed to an environment at any time (e.g., with deployment then triggered manually or automatically). Accordingly, as described herein, CI/CD techniques may bridge gaps between development and operation activities and software development teams by enforcing automation in building, testing, and deploying software applications.

### SUMMARY

Some implementations described herein relate to a system for diagnosing code pipeline failures. The system may include one or more memories and one or more processors communicatively coupled to the one or more memories. The one or more processors may be configured to track information associated with a first execution of a code pipeline to deploy an updated version of software associated with the code pipeline. The one or more processors may be configured to receive an indication of a failure in a second execution of the code pipeline, wherein the second execution of the code pipeline is triggered by a commit of source code to a source code repository. The one or more processors may be configured to determine a cause of the failure in the second execution of the code pipeline. The one or more processors may be configured to generate information indicating whether the updated version of the software associated with the code pipeline or the source code committed to the source code repository is the cause of the failure in the second execution of the code pipeline.

Some implementations described herein relate to a method for diagnosing code pipeline failures. The method may include tracking, by a fault diagnosis system, information associated with a first execution of a code pipeline to deploy an updated version of software associated with the code pipeline. The method may include receiving, by the fault diagnosis system, an indication of a failure in a second execution of the code pipeline, wherein the second execution of the code pipeline is triggered by a commit of source code to a source code repository. The method may include determining, by the fault diagnosis system, whether the updated version of the software associated with the code pipeline or the source code committed to the source code repository is a cause of the failure in the second execution of the code pipeline. The method may include sending, by the fault diagnosis system to a developer system, a request to plan code development to resolve the cause of the failure in the second execution of the code pipeline.

Some implementations described herein relate to a non-transitory computer-readable medium that stores a set of instructions. The set of instructions, when executed by one or more processors of a system, may cause the system to receive an indication of a failure in an execution of a code pipeline, wherein the execution of the code pipeline is triggered by a commit of source code to a source code repository. The set of instructions, when executed by one or more processors of the system, may cause the system to determine a cause of the failure in the execution of the code pipeline. The set of instructions, when executed by one or more processors of the system, may cause the system to generate information indicating whether the source code committed to the source code repository or an update to software associated with the code pipeline is the cause of the failure in the execution of the code pipeline.

### BRIEF DESCRIPTION OF THE DRAWINGS

FIG. 1 is a diagram illustrating an example associated with a code pipeline, in accordance with some embodiments of the present disclosure.

FIG. 2 is a diagram illustrating an example implementation associated with diagnosing failures in a code pipeline, in accordance with some embodiments of the present disclosure.

FIG. 3 is a diagram illustrating an example environment in which systems and/or methods described herein may be implemented, in accordance with some embodiments of the present disclosure.

FIG. 4 is a diagram illustrating example components of a device associated with diagnosing failures in a code pipeline, in accordance with some embodiments of the present disclosure.

FIG. 5 is a flowchart of an example process associated with diagnosing failures in a code pipeline, in accordance with some embodiments of the present disclosure.

### DETAILED DESCRIPTION

The following detailed description of example implementations refers to the accompanying drawings. The same reference numbers in different drawings may identify the same or similar elements.

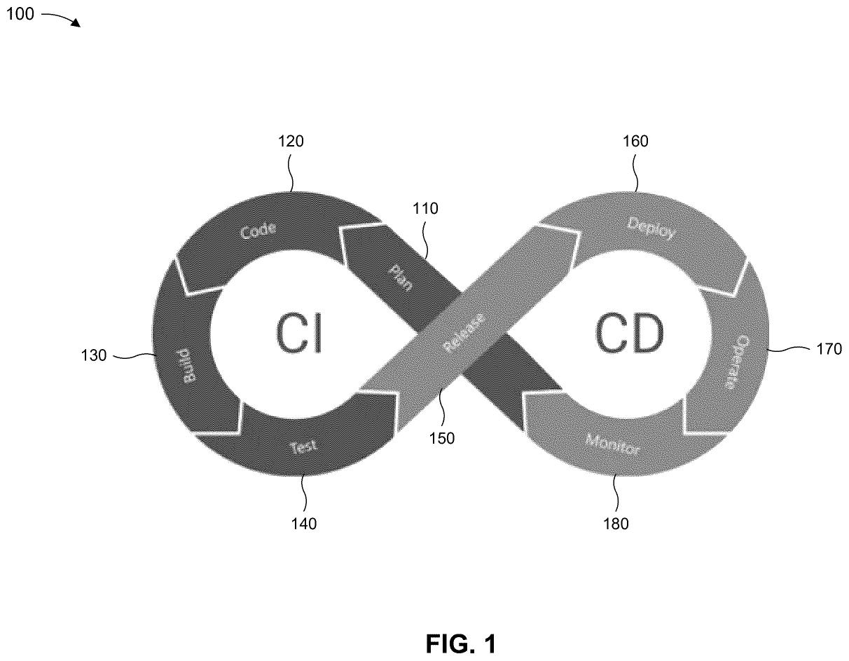

FIG. 1 is a diagram illustrating an example 100 of a code pipeline. In particular, as described herein, a code pipeline generally includes a structured process where code changes progress from initial development to deployment through various phases. The code pipeline typically involves coding, building, testing, and deployment phases that may be implemented using one or more systems to ensure that code changes are systematically and efficiently integrated into a code base and made available to end users. For example, FIG. 1 illustrates an example continuous integration and continuous deployment (CI/CD) code pipeline that is often used in a DevOps (developer and operations) software engineering methodology, where the CI/CD pipeline includes a continuous integration (CI) phase and a continuous deployment (CD) phase that may be implemented as a “continuous delivery” phase or a “continuous deployment” phase. Furthermore, because a feedback loop connects the CD phase to the CI phase, the code pipeline may be referred to as a continuous everything pipeline.

As shown in FIG. 1, the code pipeline may include a planning phase 110 that covers various processes that occur before developers start to write code. For example, in the planning phase 110, requirements and feedback may be gathered from stakeholders, customers, users, or the like and used to plan a product roadmap to guide software development. In some cases, the product roadmap may be recorded and tracked using a ticket management system or other software development platform such as Jira, Azure DevOps, or Asana, which provide various tools to track the progress, issues, and/or milestones associated with a software project. In some cases, depending on the software development methodology being used, the product roadmap may be broken down into epics, features, and user stories, creating a backlog of tasks that lead to customer requirements. The tasks in the backlog can then be used to plan software development sprints and allocate tasks to software developers or teams to begin software development.

As further shown in FIG. 1, the code pipeline may include a code phase 120. In the code phase 120, software developers use software development toolkits, plug-ins installed in desktop environments, and/or other tools or utilities to aid in the software development process, enforce consistent coding styles, and avoid common security flaws and code anti-patterns. In the code phase 120, the software development team maintains source code in a centralized code repository, which is typically implemented as a version control system (e.g., GitHub, Bitbucket, GitLab, or AWS CodeCommit), which provides tools that help developers to coordinate, collaborate, and track the tasks that each team member is performing. The code phase 120 further enables collaboration between different development teams, who check source code into the code repository, perform code reviews, and/or approve the code for further processing in the code pipeline. In some cases, during the code phase 120, automated tools may perform a static code analysis to verify that the code follows specific rules (e.g., that the code is written in a certain language, is well-documented, and/or is covered by tests, among other examples) that are defined to help identify potential issues in the code early in the code pipeline.

As further shown in FIG. 1, the code pipeline may include a build phase 130, which may be triggered when developers push or “commit” code to a code repository or version control system. For example, a developer may submit a request to merge new code or code changes with existing code in a shared codebase, and another developer then reviews the new code or the code changes to verify that the new code or the code changes satisfies appropriate requirements. If the code reviewer has feedback, the code may be returned to the developer to be reworked, or the code may be abandoned if the code reviewer rejects the new code or the code changes. If and/or when the code reviewer approves the request, an automated process may be triggered to build a codebase and run a series of integration and/or unit tests to identify any regressions. In cases where the build fails, or any of the tests fails, the request to merge the new code or the code changes fails and the developer is notified to resolve the issue(s). In this way, continuously checking code changes into a shared code repository and running builds and tests can minimize integration issues that may arise when developers work on a shared codebase and may enable identification and resolution of bugs early in the development lifecycle.

As further shown in FIG. 1, the code pipeline may include a testing phase 140 that may be triggered when a build succeeds. For example, when a build succeeds for new code or code changes that have been committed or otherwise saved to a shared code repository, the code may be automatically sent to a testing environment for more in-depth, out-of-band testing. For example, the testing environment may be an existing hosting service, or the testing environment may be a new environment provisioned as part of the deployment process (e.g., in a cloud environment) in a practice known as Infrastructure-as-Code (IaC) that is often used in a code pipeline. After the application has been deployed to the testing environment, various manual and/or automated tests may be performed. For example, manual testing may include user acceptance testing (UAT), where testers interact with the application in the same way that end users are expected to interact with the application to identify any issues or refinements that may need to be addressed before the application is deployed into a production environment. Furthermore, in some cases, automated tests may be executed to perform security scanning against the application, check for changes to an infrastructure, check for compliance with security and stability best practices, test the performance of the application, and/or run load testing, among other examples. The testing performed during the testing phase 140 may be organization-specific and/or variable depending on what is relevant to the application.

As further shown in FIG. 1, the code pipeline may include a release phase 150, which may bridge the CI phase and the CD phase. Accordingly, the release phase 150 is often a significant milestone in the code pipeline, representing a stage where a build is ready to be deployed into a production environment. By the time that code reaches the release phase 150, the code has passed various manual and/or automated tests, which assures an operations team that handles deployment that breaking issues and regressions are unlikely to occur. Depending on the organization, any build that reaches the release phase 150 of the code pipeline may be automatically deployed, in which case the CD phase may be operated as a continuous deployment phase. In such cases, developers may use feature flags to disable certain features to prevent users from accessing such features until the features have been verified to be ready for end users. Alternatively, an organization may exert more control over when builds are released to production environments. For example, an organization may implement a regular release schedule or only release new features after a milestone is reached. In such cases, a manual approval process may be implemented in the release phase 150, which allows only certain users within an organization to authorize a release into a production environment, in which case the CD phase may be operated as a continuous delivery phase.

As further shown in FIG. 1, the code pipeline may include a deploy phase 160. For example, in the deploy phase 160, a build is ready for end users and is deployed into a production environment. In general, various tools and/or processes can be used to automate the deployment process to make releases reliable with no outage window. For example, a blue-green deployment pattern may be used to switch to a new production environment with no outage. For example, a new production environment is built, and the new production environment is deployed alongside (e.g., parallel to) an existing production environment. When the new production environment is ready, a hosting service may point all new requests to the new production environment. If an issue is found with the new build at any time, the hosting service can simply point requests back to the old production environment until a fix is implemented. Other deployment patterns include A/B deployments, where different users are routed to different software versions to test and compare performance, and canary deployments, where new features are incrementally released to allow quick reversals in the event that the deployed code turns out to be buggy. In general, the same Infrastructure-as-Code that was used to build the test environment can be configured to build the new production environment, which is unlikely to result in errors because the test environment was built successfully.

As further shown in FIG. 1, the code pipeline may include an operating phase 170, where the new code release is live in the production environment and being used by end users. In the operating phase 170, one or more operations teams may monitor the new code release to verify that the new application is running as expected. In some cases, depending on a configuration of the hosting service, the production environment may automatically scale with a load to handle peaks and troughs in the number of active users. The organization may also provide one or more mechanisms for end users to provide feedback on the software service and/or tools that collect and triage the feedback to help guide the future development of the product. The feedback loop plays an important role in the code pipeline, because developers may not always know what users want, and the users may use the application for many more hours to discover issues that may not be uncovered during the testing phase 140.

As further shown in FIG. 1, the code pipeline may include a monitoring phase 180, where the production environment is monitored and user feedback gathered in the operating phase 170 is collected and analyzed to derive information related to user behavior, performance, and/or errors, among other examples. Furthermore, the monitoring phase 180 may include analysis of the code pipeline itself, monitoring for potential bottlenecks that may be slowing development cycles and/or impacting the productivity of development and/or operations teams. The information gathered in the monitoring phase 180 is then fed back to planning systems for the development team to consider and plan further code changes in a continuous manner.

Accordingly, as described herein, a typical code pipeline includes various stages, and there are commonly failures within the code pipeline. For example, after a developer commits new code or code changes to a shared code repository, failures can occur in the build phase 130 and/or the testing phase 140 in cases where the code has syntax errors, fails unit tests, and/or cannot be built due to missing dependencies or incorrect configurations, among other examples. Furthermore, in the release phase 150 and/or the deployment phase 160, failures often occur due to integration issues, where different software components do not interact correctly, or due to environment-specific problems, such as misconfigurations or missing environment variables. Furthermore, in the deploy phase 160 and/or the operating phase 170, failures can occur due to insufficient testing in previous phases, which may lead to unanticipated bugs. Alternatively, a code pipeline may fail for reasons related to the software and/or configuration of the code pipeline itself or for reasons unrelated to the code being built, tested, and deployed or the software and/or systems making up the code pipeline. For example, a deployment may fail due to network failures, incorrect permissions, or conflicts with existing production data or configurations. In other examples, the code pipeline may fail due to bugs and/or defects in the code pipeline software, due to misconfigurations of the code pipeline software, due to performance bottlenecks when there are scalability issues under a heavy load, and/or security vulnerabilities that are exploited by malicious users to gain unauthorized access or disrupt the code pipeline. Accordingly, identifying whether an error in a code pipeline is due to application code or an operational step in the code pipeline is a challenging problem.

In some implementations, as described herein, a fault diagnosis system may be configured to diagnose faults or errors that occur in a code pipeline. For example, in a code pipeline that is implemented using one or more systems or environments, a fault or error may occur when code that has been reviewed and approved fails a build or results in a build system crashing when a build is attempted, when code that has been deployed to a testing environment results in the testing environment failing (e.g., distinct from the code failing a test that is executed in the testing environment), and/or when code is unsuccessfully deployed. For example, in some implementations, the fault diagnosis system may generally monitor each execution of the code pipeline, and may track versions, configurations, settings, and/or other parameters associated with various software components and/or systems that make up the code pipeline. Accordingly, when an execution of the code pipeline succeeds, the fault diagnosis system may store information related to a baseline or reference instance of the code pipeline that is known to be stable and functional. In the event that a subsequent execution of the code pipeline fails for a given code change (e.g., the pipeline fails to pull code from a version control system, a build failure occurs, a verified and tested build fails to deploy, or the like), the fault diagnosis system may revert the code pipeline to the baseline or reference instance and attempt to process the code change through the code pipeline using the stable and functional version of the code pipeline. In this way, the fault diagnosis system may determine whether the failure in the code pipeline was caused by the code being processed through the pipeline (e.g., based on the failure occurring again when the code change is processed using the stable and functional version of the code pipeline) or another reason, such as a change to the software, configurations, and/or settings of the code pipeline (e.g., based on the code pipeline successfully executing again when the code change is processed using the stable and functional version of the code pipeline).

As indicated above, FIG. 1 is provided as an example. Other examples may differ from what is described with respect to FIG. 1.

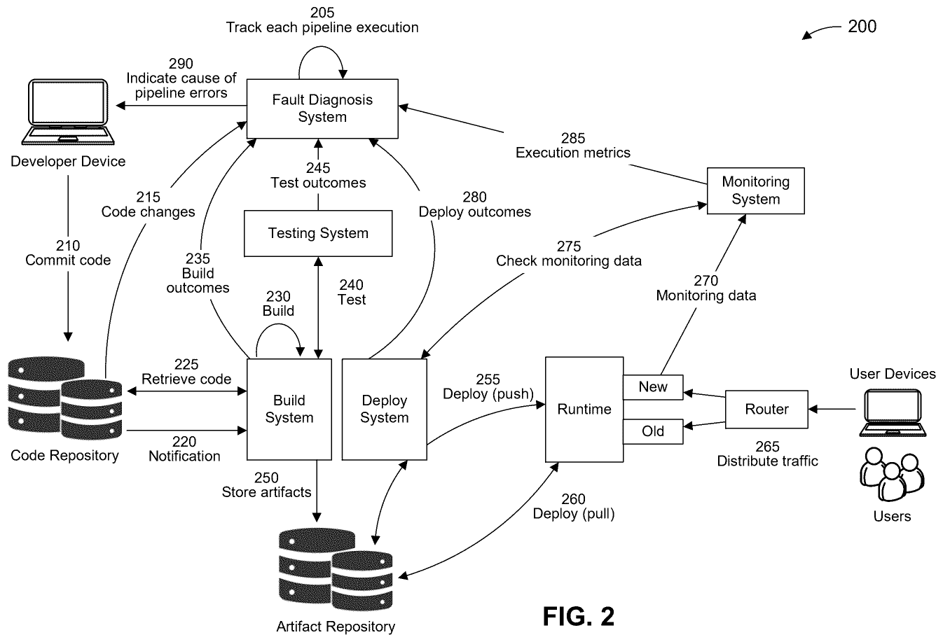

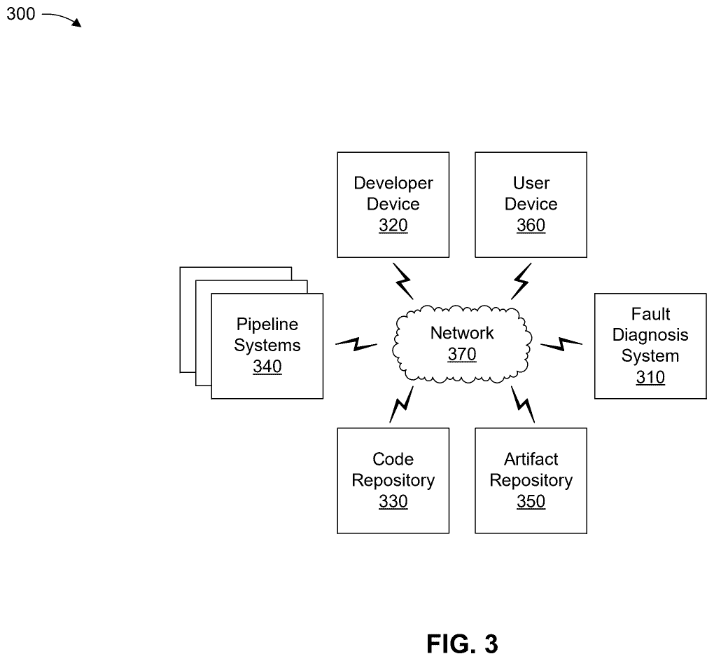

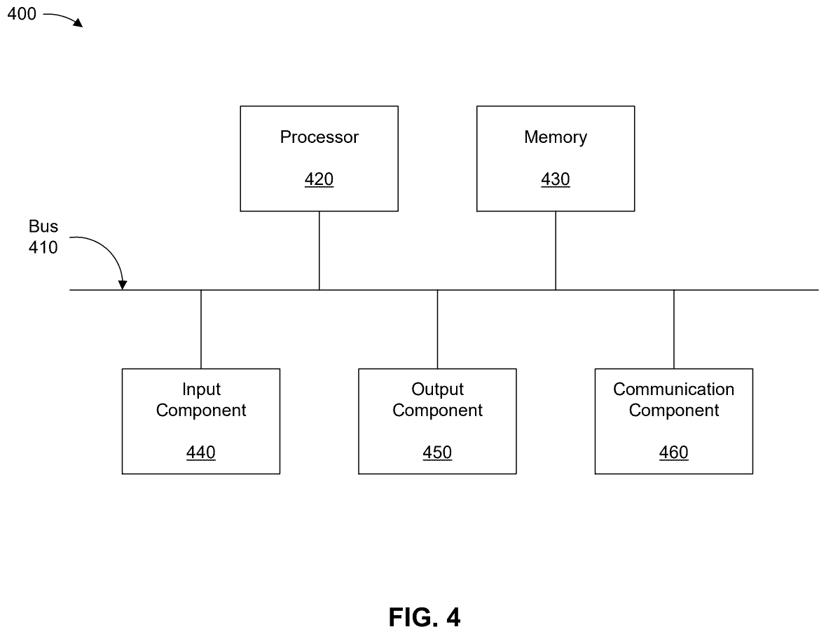

FIG. 2 is a diagram illustrating an example implementation 200 associated with diagnosing failures in a code pipeline. As shown in FIG. 2, example 200 includes a fault diagnosis system, a developer device, a code repository, an artifact repository, one or more pipeline systems (e.g., a build system, a testing system, a deploy system, a runtime environment, and a monitoring system in example implementation 200), and one or more user devices. The fault diagnosis system, the developer device, the code repository, the artifact repository, the pipeline system(s), and the user device(s) are described in more detail in connection with FIG. 3 and FIG. 4.

As described herein, the code pipeline shown in FIG. 2 is an example of a CI/CD pipeline, or a continuous everything pipeline, that is often used in a DevOps (developer and operations) software engineering methodology. However, code pipelines are also used in various other software engineering methodologies, where the specific phases in any code pipeline may overlap with and/or vary from the CI/CD pipeline shown in FIG. 2. For example, in an agile software engineering methodology, a code pipeline may include plan, collaborate, and deliver phases to develop software in iterations that include mini-increments. In a waterfall software engineering methodology, a code pipeline may include requirements, design, implementation, verification, and maintenance phases, which are performed sequentially with a requirement that each phase is complete before a next phase can start. In a rapid application development (RAD) software engineering methodology, a code pipeline may include requirements planning, user design, construction, and cutover phases, where the user design and construction phases are performed repeatedly until a clearly defined user group confirms that the product satisfies all applicable requirements. Accordingly, while some implementations are described herein in relation to a CI/CD pipeline, similar techniques may be applied for other code pipelines.

As shown in FIG. 2, and by reference number 205, the fault diagnosis system may generally track information associated with the code pipeline each time that the code pipeline is executed. For example, in some implementations, the code pipeline may include various systems and/or devices, such as the shared code repository, the artifact repository, the build system, the testing system, the deploy system, the monitoring system, and/or the runtime environment. As described herein, each system or device associated with the code pipeline may execute software, which may be updated to new versions from time to time in the same way that any other software is updated. Accordingly, each time that the code pipeline is executed, which may be triggered when a developer device commits (e.g., saves or publishes) code to the code repository, the fault diagnosis system may obtain a snapshot of the state of the systems and/or devices making up the code pipeline. For example, in some implementations, the fault diagnosis system may track the current version of software running on the shared code repository, the artifact repository, the build system, the testing system, the deploy system, the monitoring system, and/or the runtime environment, may track information related to the settings or configurations of the various systems and/or devices, and/or may monitor a status of any other resources that the various systems and/or devices utilize when executing to process new code or a code change that has been committed to the code repository. In this way, in cases where a failure occurs following a change to a version of any software running on the systems or devices making up the code pipeline and/or a change to the settings or configurations of any systems or devices making up the code pipeline, the fault diagnosis system may diagnose a cause of the fault according to a comparison between the snapshot of the code pipeline when the failure occurred and a snapshot of the code pipeline that was captured in a previous, successful execution.

For example, as shown by reference number 210, an execution of the code pipeline may be triggered when a developer commits, saves, or otherwise submits code to the code repository. For example, in a planning phase, software developers gather requirements and feedback from stakeholders, customers, users, or the like and develop a product roadmap that may be recorded and tracked using a software development platform. Each developer may generally write and test code on a local developer device using software development toolkits, plug-ins installed in desktop environments, and/or other tools or utilities to aid in the software development process. When the developer is ready to submit the code changes to the code repository, the developer may stage the changes to prepare specific files for the commit, and may create a commit message that describes the code changes implemented in the commit. In some cases, each commit may be associated with a unique identifier to help track code changes. In some implementations, the commit may then be pushed to the code repository. Furthermore, in some cases, the developer may need to authenticate with the code repository using secure shell (SSH) keys or personal access tokens. When the commit has been submitted to the code repository, a code pipeline execution may be automatically triggered, where the code pipeline includes phases to build and test the code changes, and potentially to deploy the code changes to a staging or production environment if the code changes are successfully built and pass appropriate tests. Additionally, or alternatively, in a collaborative environment, a code review process may be triggered, where the code changes are reviewed by other developers who suggest improvements or approve the changes before the code pipeline execution is triggered. As further shown by reference number 215, information related to the code changes may be provided to the fault diagnosis system. For example, the code repository may implement version control, which may allow the fault diagnosis system to track the software versions at each execution of the code pipeline. Furthermore, the information related to the code changes may include other parameters related to the code commit, such as the developer who submitted the code changes, the parameters of a connection between the developer device and the code repository, and/or software versions and/or configurations of the developer device and/or the code repository, among other examples.

In some implementations, as shown in FIG. 2, the code pipeline includes a build system, which may correspond to a server, a machine, or another suitable collection of information technology resources that are optimized for building software. Accordingly, in some implementations, a connection may be configured from the build system to the code repository to allow the build system to retrieve code from the code repository when an execution of the code pipeline is triggered by the code being committed to the code repository. Furthermore, a connection may be configured from the code repository to the build system to allow the code repository to notify the build system when code has been committed to the code repository to trigger an execution of the code pipeline. For example, as shown by reference number 220, the code repository may send a notification to the build system when the code is committed to the code repository. As further shown by reference number 225, the build system may then retrieve the code to be built from the code repository and automatically start the build phase. As further shown by reference number 230, the build system may then perform a build for the code, which may include compiling the code and packaging the code for deployment. Accordingly, the build system may generally transform human-readable code into executable or deployable artifacts that can then be tested and deployed to a production environment. Furthermore, in some implementations, the build system may perform a build verification test after a build is created to verify that all modules are correctly integrated and that critical functionalities are working. As further shown by reference number 235, information related to the build outcome may be provided to the fault diagnosis system, where the information related to the build outcome may indicate whether the build system successfully retrieved the code from the code repository, whether the build succeeded or failed, configurations and/or settings of the build system, a software version of the build system, and/or an infrastructure state or set of resources provisioned to support the build system, among other examples.

As further shown in FIG. 2, and by reference number 240, the build system may communicate with the testing system to perform automated tests to ensure that the code moving through the code pipeline satisfies applicable requirements prior to delivering or deploying new software artifacts to a production environment. For example, in some implementations, the testing system may perform unit testing to validate individual components or units of code in isolation against expected behavior of the individual components or units of code. The unit testing is generally executed every time that code changes are committed to the code repository to assess the smallest portion of the application code and ensure that the new code does not introduce software defects. Furthermore, in some implementations, the testing system may perform integration testing to ensure that components or services work together. For example, the integration tests may test interactions between different components or units of a software application, and may differ from unit tests in that integration tests are focused on how different modules in an application work together, share data, and/or communicate. As further shown in FIG. 2, and by reference number 245, information related to outcomes from the unit tests, the integration tests, and/or any other tests performed by the testing system (e.g., information related to code quality, security, or the like) may be provided to the fault diagnosis system to be analyzed when a failure occurs in the code pipeline.

As further shown in FIG. 2, and by reference number 250, the build system may store artifacts corresponding to software components that were successfully built and passed all appropriate testing in the artifact repository. For example, the artifact repository may be configured to store software artifacts for subsequent and/or repeated retrieval. In this way, the artifact repository may enable the build system and the deploy system to operate at separate times and/or on separate infrastructure, as the build system stores software artifacts in the artifact repository and the deploy system obtains the software artifacts from the artifact repository independently from the build. Furthermore, by hosting the build system and the deploy system on separate infrastructure, infrastructure optimized for the build tasks may be used entirely for the build, and the deploy system on separate infrastructure may have exclusive access to a runtime environment for the application, which may improve security. In addition, artifacts are preserved in the artifact repository after deployment, which allows artifacts to be retrieved at a subsequent time (e.g., for debugging, another deployment, and/or rollbacks).

As further shown in FIG. 2, and by reference number 255, the deploy system may employ a push deployment model, where the deploy system obtains one or more artifacts to be deployed from the artifact repository and pushes the one or more artifacts into the runtime environment when a triggering event occurs. For example, in some implementations, the triggering event may include a request from the application runtime environment. Alternatively, as shown by reference number 260, a pull deployment model may be used, where the runtime environment pulls the one or more artifacts directly from the artifact repository, in which case the deploy system may be omitted and/or integrated into the runtime environment. Furthermore, as described herein, new or updated software artifacts may be deployed to the runtime environment according to a deployment pattern that ensures that the deployment will not cause interruption. For example, as shown in FIG. 2, a second instance or set of instances of the runtime environment may be created, and the new version of the software may be installed in the second instance or set of instances of the runtime environment. As further shown by reference number 265, a router may be provided in or in front of the runtime environment, and may distribute traffic associated with user requests that are received from user devices to the appropriate version (e.g., the new version or an old version) of the software application (e.g., in an A/B deployment or a blue-green deployment). After successful deployment, end users may be routed to the instance(s) hosting the new application and the instance(s) of the runtime environment hosting the older version of the application may be removed.

As further shown in FIG. 2, and by reference number 270, monitoring data may be provided from the runtime environment to a monitoring system to enable further quality checks after and/or during deployment. For example, in addition to the tests that are run during the build and the code analysis performed by the testing system for successful builds, the monitoring system may be used to enable an incremental deployment pattern (e.g., a canary deployment). For example, in such cases, the router may direct certain users to the new version of the software application and other users to the old version of the software application, and the monitoring system may analyze the monitoring data to check the quality of the new version. Furthermore, as shown by reference number 275, the deploy system may have access to the monitoring data, and may communicate with the monitoring system to check quality metrics and determine whether to proceed with deployment, abort deployment, or roll a deployment back to an earlier version. For example, by sending only a subset of users to the new version of the application, the number of users routed to the new version of the application may be increased only when the monitoring system and the deployment system verify that the quality checks are providing positive feedback for the new version of the application. Alternatively, when issues are detected with the new version of the application, the deployment can be cancelled or rolled back, and only a subset of users are affected by the problems. As further shown by reference number 280, information related to a deployment outcome (e.g., information indicating the deployment pattern that was used, information indicating whether the deployment succeeded or failed, and/or information related to quality checks or performance metrics, among other examples) may be provided to the fault diagnosis system to evaluate when a failure occurs in the deployment pipeline. Furthermore, as shown by reference number 285, the monitoring system may send execution metrics related to performance of the new version of the application in the runtime environment to the fault diagnosis system to evaluate when a failure occurs in the deployment pipeline.

Accordingly, when the fault diagnosis system receives an indication that an execution of the code pipeline failed, the fault diagnosis system may refer to the information associated with the current (failed) execution of the code pipeline and results associated with one or more previous executions of the code pipeline. For example, after a commit to the code repository triggers an execution of the code pipeline, there are various reasons why a failure may occur, some of which may relate to the code moving through the pipeline and others which may relate to a state of the code pipeline and/or external factors. For example, in the build phase, a failure may occur due to compilation errors (e.g., syntax errors, missing dependencies, type errors, or the like) or dependency issues (e.g., version conflicts or unavailable dependencies in a repository) for the code moving through the pipeline, or due to configuration problems or resource limitations in the build system (e.g., incorrect build scripts, mismatches between a build environment and a development environment, insufficient memory or disk space to complete a build or store temporary files, or the like). Additionally, or alternatively, failures may occur due to code quality issues, where unit tests or integration tests fail, infrastructure problems (e.g., network outages) preventing access to necessary resources, security restrictions (e.g., a lack of appropriate permissions to execute certain tasks), changes in external services (e.g., changes to external application program interfaces (APIs) or external service outages), and/or due to a misconfiguration of the pipeline software or a faulty update to a version of the pipeline.

Accordingly, when a failure occurs when a code change is moving through the code pipeline, the fault diagnosis system may identify a location in the pipeline where the failure occurred (e.g., the build phase, the test phase, the deploy phase, the operate phase, or the like) and may identify a state of the pipeline when the failure occurred and one or more previous states of the code pipeline that resulted in successful building, testing, and deployment. For example, the state of the code pipeline may include versions of software running on the build system, the testing system, the deploy system, or the like, infrastructure resources allocated to the various systems, a state of external services used by the code pipeline, and/or configurations and/or settings of the software associated with the code pipeline. The fault diagnosis system may then revert to a previous state of the code pipeline that successfully executed, and attempt to process the same code that was being processed when the failure occurred using the previous state of the code pipeline. For example, in some implementations, the previous state of the code pipeline may be instantiated in a runtime environment that is provisioned for the purpose of fault diagnosis. Accordingly, if the code that was being processed when the failure occurred is able to successfully pass a phase where the failure occurred in the previous version of the code pipeline, the fault diagnosis system may determine that the failure was caused by an update to the software associated with the code pipeline or another change to the state associated with the code pipeline (e.g., if a build failure occurs when the build system is running recently updated software, and the code is successfully built when the build system is operated using a previous software version, the recently updated software may be the likely cause of the failure). Alternatively, if the code that was being processed when the failure occurred fails again when processed through the previous version of the code pipeline, the fault diagnosis system may determine that the failure was likely caused by the code moving through the code pipeline. Additionally, or alternatively, the fault diagnosis system may identify previous executions of the code pipeline associated with configurations, settings, resource states, and/or software versions that are similar to and/or different from the current (failed) execution of the code pipeline to identify patterns that may be indicative of the cause of the failure (e.g., if the build system has a certain configuration when several build failures occurred, and the build system currently has a similar configuration, the configuration may be the cause of the code pipeline failing). Accordingly, the fault diagnosis system may trigger one or more executions of the code pipeline, using different combinations of software versions, configurations, settings, or the like, to determine whether the failure in the code pipeline is caused by a change to the state of the pipeline software or by the code being processed through the code pipeline.

Accordingly, as shown by reference number 290, the fault diagnosis system may then provide, to the developer device, information indicating the cause of the error(s) in the code pipeline. For example, in cases where the source code moving through the pipeline is deemed to have caused the failure in the code pipeline, the fault diagnosis system may send a request to the developer device to plan code development for the source code that caused the failure. Similarly, in cases where a change to the software associated with the code pipeline is deemed to have caused the failure in the code pipeline, the fault diagnosis system may send a request to the developer device to plan code development for the software associated with the code pipeline. Additionally, or alternatively, the fault diagnosis system may roll back a potentially faulty update to the software associated with the code pipeline and/or notify development and/or operations personnel to resolve misconfigurations and/or problematic settings or resource allocations that may have contributed to the failure of the code pipeline. In this way, the fault diagnosis system may improve the feedback loop for the code pipeline, by providing information that may indicate issues in the code pipeline in addition to issues with the code moving through the pipeline.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include a fault diagnosis system 310, a developer device 320, a code repository 330, one or more pipeline systems 340, an artifact repository 350, a user device 360, and a network 370. Devices of environment 300 may interconnect via wired connections, wireless connections, or a combination of wired and wireless connections.

The fault diagnosis system 310 may include one or more devices capable of receiving, generating, storing, processing, providing, and/or routing information associated with diagnosing faults in a code pipeline, as described elsewhere herein. The fault diagnosis system 310 may include a communication device and/or a computing device. For example, the fault diagnosis system 310 may include a server, such as an application server, a client server, a web server, a database server, a host server, a proxy server, a virtual server (e.g., executing on computing hardware), or a server in a cloud computing system. In some implementations, the fault diagnosis system 310 may include computing hardware used in a cloud computing environment.

The developer device 320 may include one or more devices capable of receiving, generating, storing, processing, and/or providing information associated with code to be built, tested, deployed, and/or monitored via a code pipeline, as described elsewhere herein. The developer device 320 may include a communication device and/or a computing device. For example, the developer device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The code repository 330 may include one or more devices capable of receiving, generating, storing, processing, and/or providing information associated with code to be built, tested, deployed, and/or monitored via a code pipeline, as described elsewhere herein. The code repository 330 may include a communication device and/or a computing device. For example, the code repository 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the code repository 330 may store code that is committed by a user of the developer device 320, which may trigger one or more code pipeline processes to build, test, deploy, and/or monitor the code, as described elsewhere herein.

The one or more pipeline systems 340 may include one or more devices capable of receiving, generating, storing, processing, providing, and/or routing information associated with code to be built, tested, deployed, and/or monitored, as described elsewhere herein. For example, in some implementations, the one or more pipeline systems 340 may include the build system, the testing system, the deploy system, the runtime environment, and/or the monitoring system described with reference to FIG. 2. The one or more pipeline systems 340 may include a communication device and/or a computing device. For example, the one or more pipeline systems 340 may include a server, such as an application server, a client server, a web server, a database server, a host server, a proxy server, a virtual server (e.g., executing on computing hardware), or a server in a cloud computing system. In some implementations, the one or more pipeline systems 340 may include computing hardware used in a cloud computing environment.

The artifact repository 350 may include one or more devices capable of receiving, generating, storing, processing, and/or providing information associated with code that has been successfully built and tested and/or code artifacts that are ready to be deployed to a runtime environment and/or monitored, as described elsewhere herein. The artifact repository 350 may include a communication device and/or a computing device. For example, the artifact repository 350 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the artifact repository 350 may store code that has been successfully built and tested and/or code artifacts that are ready to be deployed to a runtime environment and/or monitored, as described elsewhere herein.

The user device 360 may include one or more devices capable of receiving, generating, storing, processing, and/or providing information associated with code that the one or more pipeline systems 340 have deployed to a runtime environment, as described elsewhere herein. The user device 360 may include a communication device and/or a computing device. For example, the user device 360 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 370 may include one or more wired and/or wireless networks. For example, the network 370 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 370 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with diagnosing failures in a code pipeline. The device 400 may correspond to the fault diagnosis system 310, the developer device 320, the code repository 330, the one or more pipeline systems 340, the artifact repository 350, and/or the user device 360. In some implementations, the fault diagnosis system 310, the developer device 320, the code repository 330, the one or more pipeline systems 340, the artifact repository 350, and/or the user device 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

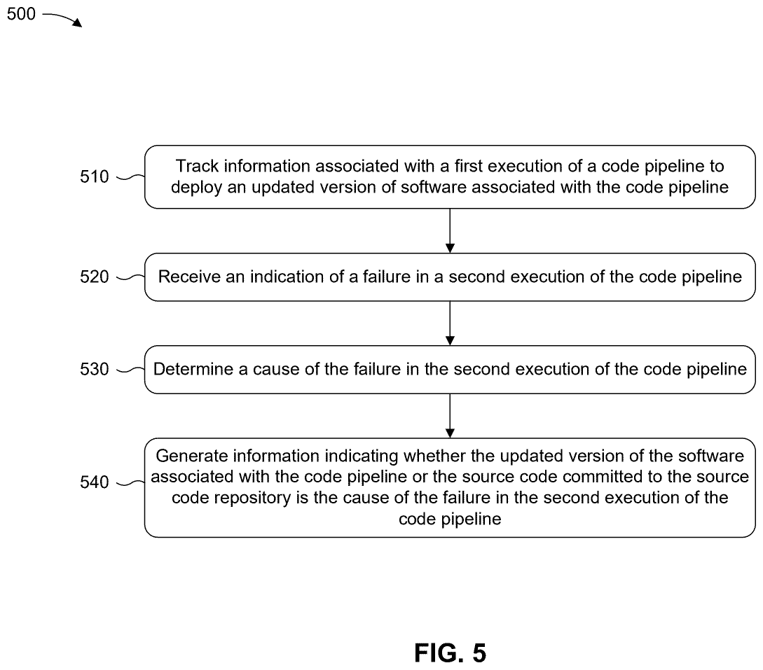

FIG. 5 is a flowchart of an example process 500 associated with diagnosing failures in a code pipeline. In some implementations, one or more process blocks of FIG. 5 may be performed by the fault diagnosis system 310. In some implementations, one or more process blocks of FIG. 5 may be performed by another device or a group of devices separate from or including the fault diagnosis system 310, such as the developer device 320, the code repository 330, the one or more pipeline systems 340, the artifact repository 350, and/or the user device 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include tracking information associated with a first execution of a code pipeline to deploy an updated version of software associated with the code pipeline (block 510). For example, the fault diagnosis system 310 (e.g., using processor 420 and/or memory 430) may track information associated with a first execution of a code pipeline to deploy an updated version of software associated with the code pipeline, as described above in connection with reference number 205-285 of FIG. 2. As an example, when new code or a code change to software associated with the code pipeline is committed or otherwise saved to a shared code repository, an execution of the code pipeline may be triggered for the updated version of the software associated with the code pipeline. Accordingly, the fault diagnosis system may track information associated with an execution of the code pipeline for the new code or the code change to software associated with the code pipeline, where the execution of the code pipeline may include a build phase, a test phase, and a deploy phase to deploy the updated version of the code pipeline software.

As further shown in FIG. 5, process 500 may include receiving an indication of a failure in a second execution of the code pipeline (block 520). For example, the fault diagnosis system 310 (e.g., using processor 420, memory 430, input component 440, and/or communication component 460) may receive an indication of a failure in a second execution of the code pipeline, as described above in connection with reference number 215, 235, 245, 280, and/or 285 of FIG. 2. As an example, the failure may include a build system failing to retrieve code to be compiled or otherwise built from a shared code repository, the build system crashing when attempting to build code retrieved from the shared code repository, a testing environment failing to provision for testing a code build, a deploy system failing to deploy a build that has passed appropriate testing when scheduled, or the like. In some implementations, the second execution of the code pipeline is triggered by a commit of source code to a source code repository. As an example, when a developer publishes, saves, or otherwise commits source code to a source code repository, the commit may trigger execution of the code pipeline, which may start with a build phase in which the code is retrieved from the code repository for building.

As further shown in FIG. 5, process 500 may include determining a cause of the failure in the second execution of the code pipeline (block 530). For example, the fault diagnosis system 310 (e.g., using processor 420 and/or memory 430) may determine a cause of the failure in the second execution of the code pipeline, as described above in connection with reference number 290 of FIG. 2. As an example, in the first execution of the code pipeline, the software associated with one or more systems in the code pipeline may be updated to a new version. Accordingly, when a subsequent execution of the code pipeline fails, the failure could potentially be caused by the code moving through the code pipeline, or by the previous update to the version of the software associated with the code pipeline. Accordingly, in one example, the fault diagnosis system may provision an instance of the code pipeline (e.g., in a virtual environment) corresponding to an earlier version that functioned correctly and attempt to process the code that was moving through the code pipeline when the failure occurred using the instance of the code pipeline corresponding to the earlier, functioning version of the code pipeline. Additionally, or alternatively, the fault diagnosis system may identify any configuration changes, setting changes, network activity logs, or other logs to identify anomalies or discrepancies between the failed execution of the code pipeline and an earlier instance that worked correctly. In this way, by attempting to process the code using working instances of the code pipeline, the fault diagnosis system may determine whether the failure was caused by changes to the software, configurations, and/or settings of the code pipeline, by the code moving through the pipeline, or by other factors (e.g., a security breach or network outage).

As further shown in FIG. 5, process 500 may include generating information indicating whether the updated version of the software associated with the code pipeline or the source code committed to the source code repository is the cause of the failure in the second execution of the code pipeline (block 540). For example, the fault diagnosis system 310 (e.g., using processor 420 and/or memory 430) may generate information indicating whether the updated version of the software associated with the code pipeline or the source code committed to the source code repository is the cause of the failure in the second execution of the code pipeline, as described above in connection with reference number 290 of FIG. 2. As an example, the diagnosis of the fault may be provided back to a developer device or another suitable system (e.g., an operations system) to indicate the reason for the failure of the code pipeline such that appropriate action may be taken (e.g., debugging the code that was moving through the pipeline when the failure occurred when the code is deemed to have caused the failure, debugging the updated version of the pipeline software when the updated version of the pipeline software, or adjusting configurations of the pipeline systems when a misconfiguration caused the failure).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for diagnosing code pipeline failures, comprising:
one or more memories; and
one or more processors, communicatively coupled to the one or more memories, configured to:
track information associated with a first execution of a code pipeline to deploy an updated version of software associated with the code pipeline;
receive an indication of a failure in a second execution of the code pipeline,
wherein the second execution of the code pipeline is triggered by a commit of source code to a source code repository;
determine a cause of the failure in the second execution of the code pipeline; and
generate information indicating whether the updated version of the software associated with the code pipeline or the source code committed to the source code repository is the cause of the failure in the second execution of the code pipeline.

2. The system of claim 1, wherein the one or more processors, to determine the cause of the failure in the second execution of the code pipeline, are configured to:
trigger a third execution of the code pipeline, using a previous version of the software associated with the code pipeline, for the source code committed to the source code repository,
wherein an outcome from the third execution of the code pipeline indicates the cause of the failure in the second execution of the code pipeline.

3. The system of claim 2, wherein the one or more processors are configured to determine that the source code committed to the source code repository is the cause of the failure in the second execution of the code pipeline based on the third execution of the code pipeline failing.

4. The system of claim 3, wherein the one or more processors are further configured to:
send, to a developer system, a request to plan code development for the source code that caused the failure in the second execution of the code pipeline.

5. The system of claim 2, wherein the one or more processors are configured to determine that the updated version of the software associated with the code pipeline is the cause of the failure in the second execution of the code pipeline based on the third execution of the code pipeline succeeding.

6. The system of claim 5, wherein the one or more processors are further configured to:
send, to a developer system, a request to plan code development for the updated version of the software associated with the code pipeline that caused the failure in the second execution of the code pipeline.

7. The system of claim 5, wherein the one or more processors are further configured to:
trigger a fourth execution of the code pipeline to roll back the updated version of the software associated with the code pipeline and deploy the previous version of the software associated with the code pipeline based on the third execution of the code pipeline succeeding.

8. The system of claim 1, wherein the failure in the second execution of the code pipeline is associated with one or more of a build phase, a test phase, or a deploy phase.

9. A method for diagnosing code pipeline failures, comprising:
tracking, by a fault diagnosis system, information associated with a first execution of a code pipeline to deploy an updated version of software associated with the code pipeline;
receiving, by the fault diagnosis system, an indication of a failure in a second execution of the code pipeline,
wherein the second execution of the code pipeline is triggered by a commit of source code to a source code repository;
determining, by the fault diagnosis system, whether the updated version of the software associated with the code pipeline or the source code committed to the source code repository is a cause of the failure in the second execution of the code pipeline; and
sending, by the fault diagnosis system to a developer system, a request to plan code development to resolve the cause of the failure in the second execution of the code pipeline.

10. The method of claim 9, wherein determining the cause of the failure in the second execution of the code pipeline comprises:
triggering a third execution of the code pipeline, using a previous version of the software associated with the code pipeline, for the source code committed to the source code repository,
wherein an outcome from the third execution of the code pipeline indicates the cause of the failure in the second execution of the code pipeline.

11. The method of claim 10, wherein the source code committed to the source code repository is the cause of the failure in the second execution of the code pipeline based on the third execution of the code pipeline failing.

12. The method of claim 11, wherein the request is to plan code development for the source code that caused the failure in the second execution of the code pipeline.

13. The method of claim 10, wherein the updated version of the software associated with the code pipeline is the cause of the failure in the second execution of the code pipeline based on the third execution of the code pipeline succeeding.

14. The method of claim 13, wherein the request is to plan code development for the updated version of the software associated with the code pipeline that caused the failure in the second execution of the code pipeline.

15. The method of claim 13, further comprising:
triggering a fourth execution of the code pipeline to roll back the updated version of the software associated with the code pipeline and deploy the previous version of the software associated with the code pipeline based on the third execution of the code pipeline succeeding.

16. A non-transitory computer-readable medium storing a set of instructions, the set of instructions comprising:
one or more instructions that, when executed by one or more processors of a system, cause the system to:
receive an indication of a failure in an execution of a code pipeline,
wherein the execution of the code pipeline is triggered by a commit of source code to a source code repository;
determine a cause of the failure in the execution of the code pipeline; and
generate information indicating whether the source code committed to the source code repository or an update to software associated with the code pipeline is the cause of the failure in the execution of the code pipeline.

17. The non-transitory computer-readable medium of claim 16, wherein the one or more instructions, that cause the system to determine the cause of the failure in the execution of the code pipeline, cause the system to:
execute the code pipeline, using a previous version of the software associated with the code pipeline, for the source code committed to the source code repository; and
determine that the source code committed to the source code repository is the cause of the failure in the execution of the code pipeline based on the code pipeline failing using the previous version of the software associated with the code pipeline.

18. The non-transitory computer-readable medium of claim 16, wherein the one or more instructions, that cause the system to determine the cause of the failure in the execution of the code pipeline, cause the system to:
execute the code pipeline, using a previous version of the software associated with the code pipeline, for the source code committed to the source code repository; and
determine that the update to the software associated with the code pipeline is the cause of the failure in the execution of the code pipeline based on the code pipeline succeeding using the previous version of the software associated with the code pipeline.

19. The non-transitory computer-readable medium of claim 16, wherein the one or more instructions further cause the system to:
revert to a previous version of the software associated with the code pipeline based on the update to the software associated with the code pipeline being the cause of the failure in the execution of the code pipeline.

20. The non-transitory computer-readable medium of claim 16, wherein the failure in the execution of the code pipeline is associated with one or more of a build phase, a test phase, or a deploy phase.
